(19) United States
(12) Patent Application Publication
(10) Pub. No.: US 2012/0288055 A1
(43) Pub. Date: Nov. 15, 2012

(54) X-RAY HOLOGRAPHY LIGHT SOURCE ELEMENT AND X-RAY HOLOGRAPHY SYSTEM

(75) Inventors: Atsushi Komoto, Moriya-shi (JP); Kohei Okamoto, Yokohama-shi (JP); Hirokatsu Miyata, Hadano-shi (JP)

(73) Assignee: CANON KABUSHIKI KAISHA, Tokyo (JP)

(21) Appl. No.: 13/466,459

(22) Filed: May 8, 2012

(30) Foreign Application Priority Data
May 13, 2011 (JP) 2011-108450

(51) Int. Cl. G03H 5/00

(52) U.S. Cl. 378/36

(57) ABSTRACT

An X-ray holography light source element divides an entering X-ray beam to emit two or more mutually coherent X-ray beams. The light source element includes an X-ray waveguide which has a core and a cladding. The core contains a plurality of substances different in a refractive-index real part and is a periodic structure body in which basic structures are periodically disposed; the cladding confines an X-ray to the core to be guided therethrough. The total reflection critical angle of the X-ray on the interface of the core and the cladding is larger than the Bragg angle corresponding to the periodicity of the basic structures of the core. A shield member provided with two or more opening portions for respectively emitting the two or more mutually coherent X-ray beams is disposed at the end portion at an emission side of the X-ray waveguide.

### BACKGROUND OF THE INVENTION

1. Field of the Invention

The present invention relates to an X-ray holography light source element capable of providing two mutually coherent X-ray beams and an X-ray holography system using the same. In particular, the X-ray holography light source element uses X-ray beams having spatial coherence provided by an X-ray waveguide employing a periodic structure body for the core.

2. Description of the Related Art

In recent years, an X-ray waveguide for electromagnetic waves in an X-ray region has been proposed. The X-ray waveguide can provide X-ray beams in which the X-ray phase is controlled on a waveguide cross-section and which has spatial coherence. Due to the characteristics, the X-ray waveguide is frequently utilized as an element which provides an X-ray light source for carrying out X-ray holography (hereinafter referred to as an X-ray holography light source element).

Holography methods are roughly classified into in-line holography and off-axis holography. The in-line holography has a problem in that an object wave (X-rays for holography) and a conjugate wave may form an image in the same direction, so that the image becomes blurred, which is referred to as a double image. In contrast, the off-axis holography has a feature in that since an object wave and a conjugate wave which progress from different directions interfere to form an image, a double image is separated, so that the image becomes clearer than that of the in-line holography. However, the off-axis holography requires two mutually coherent X-ray beams. Non-Patent Document 1, “Waveguide-based off-axis holography with hard X rays.”, by Fuhse, et al., Physical Review Letters, 97 (25) (2006), discloses an element in which two curved X-ray waveguides are placed side by side as an X-ray holography light source element which provides two mutually coherent X-ray beams.

In Non-Patent Document 1, the element in which two curved X-ray waveguides are disposed is used as the X-ray holography light source element. This is because even in the case of an X-ray having relatively good spatial coherence, such as radiation, the area of the spatial coherence is only about 100 nm. In the X-ray holography light source element of Non-Patent Document 1, the two X-ray waveguides of an X-ray incident portion are made to be close to each other so that the distance therebetween is about 100 nm, and mutually coherent X-rays are made to enter. In addition, the X-ray waveguides are curved, and X-rays are made to emit from positions apart from each other (about 5 μm interval) in such a manner that a double image can be separated.

When curving the X-ray waveguide, the curvature of the waveguide needs to be made as small as possible in accordance with a very small total reflection critical angle at the interface of a cladding and a core. Therefore, the distance of the X-ray waveguide needs to be as long as 3 mm or more, and the intensity of the X-ray beam provided by the X-ray holography light source element is limited.

### SUMMARY OF THE INVENTION

The present invention provides an X-ray holography light source element in which an X-ray waveguide does not need to be curved and two or more mutually coherent X-ray beams with high intensity can be emitted using an X-ray waveguide having a relatively short length which guides X-rays. An X-ray holography system using the X-ray holography light source element is also disclosed.

An X-ray holography light source element which divides an entering X-ray to emit two or more mutually coherent X-ray beams, has: an X-ray waveguide which has a core and a cladding; the core contains a plurality of substances different in a refractive-index real part and is a periodic structure body in which basic structures are periodically disposed, the cladding confines an X-ray to core to be guided therethrough; the total reflection critical angle of the X-ray on the interface of the core and the cladding is larger than a Bragg angle corresponding to the periodicity of the basic structure of the core. A shield member disposed at an end portion at an emission side of the X-ray waveguide is provided with two or more opening portions for respectively emitting the two or more mutually coherent X-ray beams.

An X-ray holography system, has: an X-ray detector which detects an X-ray; and an X-ray holography light source element which divides an entering X-ray to emit two or more mutually coherent X-ray beams; in which the X-ray holography light source element has: an X-ray waveguide which has a core which contains a plurality of substances different in a refractive-index real part and is a periodic structure body in which basic structures are periodically disposed and a cladding which confines an X-ray to be guided, in which the total reflection critical angle of the X-ray on the interface of the core and the cladding is larger than the Bragg angle corresponding to the periodicity of the basic structure of the core, and which wave-guides an entering X-ray; and a shield member disposed at an end portion at an emission side of the X-ray waveguide and provided with two or more opening portions emitting X-ray beams.

Further features of the present invention will become apparent from the following description of exemplary embodiments with reference to the attached drawings.

### BRIEF DESCRIPTION OF THE DRAWINGS

FIG. 1 is a schematic view illustrating an X-ray holography light source element according to one embodiment of the invention.

FIG. 2 is a schematic view illustrating an X-ray waveguide in accordance with one embodiment of the invention.

FIG. 3 is an explanatory view illustrating an X-ray electric field intensity distribution in a periodic structure body of a core of the waveguide in accordance with one embodiment of the invention.

FIGS. 4A and 4B are graphs illustrating a waveguide mode (periodic resonant waveguide mode) originating from a periodic structure body.

FIG. 5 is a schematic view illustrating a two-dimensionally confining X-ray waveguide.

FIG. 6 is a view illustrating an electric field intensity distribution in a surface perpendicular to the z direction of the X-ray waveguide of FIG. 5.

FIG. 7 is a schematic view illustrating an end portion of an X-ray holography light source element of Example 1.

FIG. 8 is a schematic view illustrating an end portion of an X-ray holography light source element of Example 2.

### DESCRIPTION OF THE EMBODIMENTS

An X-ray holography light source element, according to one embodiment of the present invention, divides an entering X-ray to emit two or more mutually coherent X-ray beams. The X-ray holography light source element has an X-ray waveguide which has a guiding core (core) and a cladding which confines an X-ray to be guided and divides an entering X-ray and a shield member which is disposed at an end portion at an emission side of the X-ray waveguide and is provided with two or more opening portions emitting X-ray beams. The X-ray waveguide has a feature in that the core is a periodic structure body in which a plurality of basic structures containing substances different in a refractive-index real part are periodically disposed and the total reflection critical angle of the X-ray at the interface of the core and the cladding is larger than the Bragg angle corresponding to the periodicity of the basic structures of the core.

The X-ray holography system according to the invention has the above-described X-ray holography light source element, an incident X-ray, and an X-ray detector.

It is suitable that the core contains a multilayer film or a mesoporous film. It is also suitable that the core is produced by a self-assembly process using a reaction liquid containing an amphiphilic organic substance.

As described later, since the X-ray waveguide for use in the invention contains the periodic structure body for the core, an X-ray beam in which the size of a portion having spatial coherence is large can be extracted. Therefore, by disposing the shield member having the opening portions emitting X-ray beams at the end portion at the emission side of the X-ray waveguide, the X-ray is divided into mutually coherent X-ray beams to be used as the light source for X-ray holography. Holography is performed by irradiating a holography target (sample) with one beam (object light), and utilizing the interference with the other beam (reference light).

In the X-ray holography light source element of the invention, the X-ray waveguide constituting the element can guide X-ray beams having higher spatial coherence than conventional waveguides of this type. Therefore, for example, an X-ray (monochromatic X-ray) of a single wavelength which is made to enter the beam thereof is divided into two beams, so that mutually coherent X-ray beams can be provided. The term “mutually coherent”, as used herein, implies radiation waves exhibit a substantially constant phase relationship. The propagation loss of the X-ray waveguide constituting the X-ray holography light source element of the invention is smaller than that of a former X-ray waveguide and the X-ray waveguide does not need to be curved. Therefore, a wave-guiding distance can be made shorter than in conventional waveguides and two mutually coherent X-ray beams with higher intensity can be provided.

In the X-ray holography light source element of the invention, an advanced periodic structure body can be produced by an easy process by producing the periodic structure body serving as the core of the X-ray waveguide by the self-assembly process of an amphiphilic organic substance. Therefore, an excellent X-ray holography light source element can be manufactured with ease, in a short time, and at a low cost. Moreover, by adjusting the production conditions in this process, the optical characteristics of the X-ray holography light source element can be controlled.

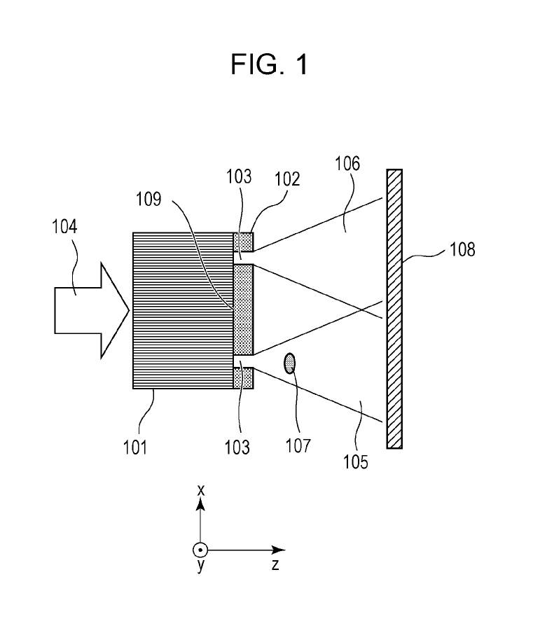

FIG. 1 is a schematic view illustrating one embodiment of the X-ray holography light source element as viewed from the top. In FIG. 1, the X-ray holography light source element according to the invention has an X-ray waveguide 101 and a shield member 102 provided with two or more opening portions 103. The shield member 102 is disposed at an end portion 109 at an emission side of the X-ray waveguide 101. When an incident X-ray 104 enters the X-ray waveguide 101, a waveguide mode is excited in the X-ray waveguide. The waveguide mode refers to an X-ray beam having a peculiar electric field profile which can be formed in the X-ray waveguide. Since the periodic structure body is used for the core of the X-ray waveguide 101, a waveguide mode which resonates with the periodic structure body and in which the propagation loss is remarkably small is selectively penetrated. Since the waveguide mode is an X-ray beam having high spatial coherence with a larger region than before, the X-ray can be divided using the shield member 102 having the opening portions 103 to emit two mutually coherent X-ray beams.

Among the two mutually coherent X-ray beams, one X-ray beam is utilized as an object light 105 which irradiates a holography target (sample) 107 and the other one is utilized as a reference light 106 for obtaining phase information by interference. The interference pattern of the object light 105 and the reference light 106 is obtained by the X-ray detector 108. By subjecting the interference pattern obtained by the X-ray detector 108 to a reconstruction operation of phase information, a holographic image of the holography target 107 can be obtained.

When X-rays with a wavelength of 0.2 nm or more (6.2 keV or lower) are included in the wavelength range of the incident X-ray 104, the absorption or the like of the X-rays by air become noticeable. Therefore, the entire X-ray spectral system may be covered with a vacuum chamber to reduce the pressure in the system.

### X-ray Waveguide

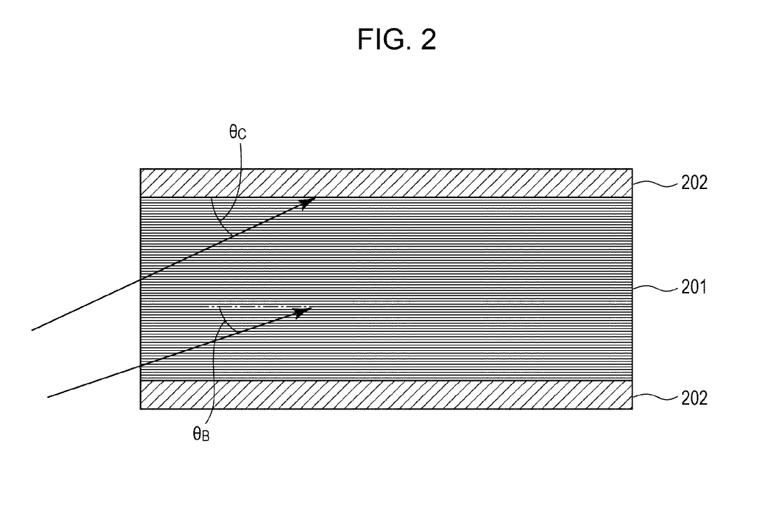

FIG. 2 is a schematic view illustrating one embodiment of the X-ray waveguide for use in the invention. The X-ray waveguide according to the invention is constituted by a core 201 which contains a plurality of substances different in a refractive-index real part and is a periodic structure body in which basic structures are periodically disposed X-ray and claddings 202 for confining the X-rays in the core. The core 201 contains a periodic structure body formed by periodically disposing a plurality of basic structures containing a plurality of substances different in a refractive index real part. The total reflection critical angle θ_{C} of the X-rays at the interface of the cladding and the core is larger than the Bragg angle θ_{H} corresponding to the periodicity of the basic structures of the periodic structure body of the core (θ_{B}<θ_{C}). As understood by persons of ordinary skill in the art, the concept of the “Bragg angle” is generally defined by Bragg's law. Therefore, in the present specification, the ordinary meaning of “Bragg angle” will be limited to that defined by Bragg's law.

The X-ray waveguide for use in the invention is an X-ray waveguide capable of selectively utilizing a waveguide mode corresponding to the periodicity of the periodic structure body by the use of the periodic structure body for the core 201.

### X-ray

The X-ray is an electromagnetic wave in a wavelength region where the refractive-index real part of substances is 1 or lower. Specifically, the X-ray in the invention refers to an electromagnetic wave with a wavelength of 100 nm or lower containing an extreme ultra violet (EUV) light. Since the frequency of the electromagnetic wave of such a short wavelength is very high and the outermost shell electrons of substances cannot respond, the frequency band is different from the frequency band of electromagnetic waves (visible light or infrared rays) having a wavelength equal to or higher than the wavelength of UV light. It is known that the real part of the refractive index of substances to X-rays is smaller than 1. As represented by the following Equation (1),

n=1−δ−i\tilde{β}=ñ−i\tilde{β} (1)

the refractive index n of substances to such an X-ray is represented using a shift amount δ from 1 of the real part and an imaginary number part \tilde{β} relating to absorption represented by the following Equation (2).

\tilde{β} (2)

Except for a case where the energy absorption end peculiar to atoms contributes, since δ is generally proportional to the electron density ρe of substances, the refractive-index real part becomes smaller in substances with a higher electron density. The refractive-index real part is represented by the following Equation (3).

ñ=1−δ (3)

Furthermore, the electron density ρe is proportional to the atomic density ρa and the atomic number Z. Thus, although the refractive index of substances to X-rays is represented by a complex number, the real part is referred to as a refractive-index real part or a real part of a refractive index in this description and the imaginary part is referred to as a refractive index imaginary part or an imaginary part of a refractive index.

In this description, a vacuum is also considered as one of the substances. Although a substance in which the refractive-index real part reaches the maximum is a vacuum, the refractive-index real part of air reaches the maximum to almost all the substances that are not in a gaseous state under a general environment. In the invention, two or more kinds of substances different in the refractive-index real part are two or more kinds of substances different in the electron density in many cases.

### Relationship Between Core and Cladding

The X-ray waveguide for use in the invention has a core and a cladding and confines X-rays in the core by the total reflection on the interface of the core and the cladding to wave-guide the X-rays. In order to realize the total reflection, the X-ray waveguide for use in the invention has a refractive-index real part of a core material located at the interface with the cladding larger than the refractive-index real part of a cladding material.

In the invention, the total reflection critical angle on the interface of the core and the cladding is represented by θ_{C} as the angle from the interface of the core and the cladding as represented in FIG. 2.

### Core

In the X-ray waveguide for use in the invention, a periodic structure body containing a plurality of substances different in the refractive-index real part is used for the core. Due to the fact that the core has the periodic structure, the waveguide mode formed in the waveguide resonates with the periodic structure. In such a periodic structure having different refractive-index real parts, when the periodicity is infinite, a photonic band is formed between the propagation constant and the angle frequency of X-rays, so that X-rays other than X-rays having a specific mode corresponding to the periodicity cannot be present in this structure.

The periodic structure body is a structure body in which basic structures are periodically arranged. A one-dimensional periodic structure or a three-dimensional periodic structure can be mentioned as an example. Specifically mentioned are a one-dimensional periodic structure in which a laminar structure is the basic structure and the laminar structure is laminated, a two-dimensional periodic structure in which a cylindrical structure is the basic structure and the cylindrical structure is laminated, a three-dimensional periodic structure in which a cage structure is the basic structure and the cage structure is laminated, and the like.

The waveguide mode which resonates with the periodic structure formed in the X-ray waveguide for use in the invention originates from multiple reflection corresponding to each dimension of the periodic structure of the periodic structure body. Such a waveguide mode is formed with the periodicity and the positions of the antinode and the node of the electric field intensity distribution of X-rays are in agreement with the positions thereof in regions of substances constituting the basic structures. In this case, a region of a substance with a low electron density of the periodic structure body serves as the antinode. More specifically, since the electric field intensity of X-rays concentrate on a substance with small penetration loss, the propagation loss of the waveguide mode becomes remarkably small as compared with other waveguide modes, so that the waveguide mode can be selectively extracted. Hereinafter, the waveguide mode is referred to as a periodic resonant waveguide mode.

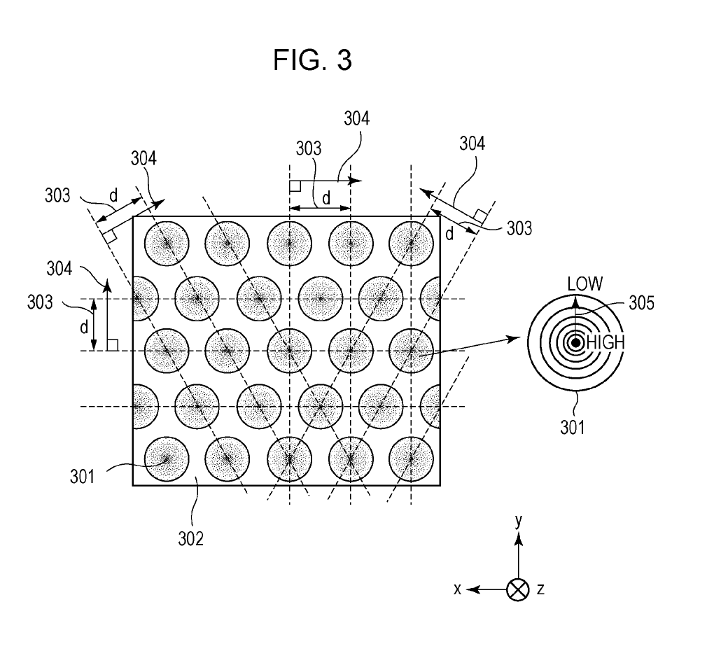

FIG. 3 is an explanatory view illustrating the X-ray electric field intensity distribution in the periodic structure body of the core. FIG. 3 illustrates an example of the electric field intensity distribution of X-rays in the periodic structure body in which cylindrical air holes 301 extending in one direction form a three-dimensional triangular lattice structure in a direction (x-y in-plane direction) perpendicular to the longitudinal direction (z direction in the drawing) in a silica 302. The X-ray propagation direction is a direction perpendicular to the sheet (z direction). A structural periodicity 303(d) is defined as the period (interval between the dashed lines of FIG. 3) of the periodic structures periodically disposed in a direction (x-y plane) perpendicular to the wave-guiding direction (propagation direction, z direction) as illustrated in FIG. 3, and the size varies depending on the periodic structure. The direction of the periodic structures (direction perpendicular to the dashed line on the x-y plane in FIG. 3) is defined as a period direction 304 in this description. In the case of periodic structures of two or more dimensions as illustrated in FIG. 3, a plurality of the structural periodicities 303 and period directions 304 are present. The structural periodicity 303 and the period direction 304 can be measured by X-ray diffraction. Although the number of the structural periodicities 303 and the period directions 304 of FIG. 3 is four, the number thereof is not limited thereto.

In FIG. 3, the structural periodicity d is represented by the dashed line. The monochrome contrast in the cylindrical air holes 301 represents the electric field intensity of X-rays and the black and the white are equivalent to the degrees of the electric field intensity, i.e., high and low, respectively. The electric field intensity is described by the space of a large number of circles in place of the monochrome contrast. The size of the space of the large number of circles in the cylindrical air holes 301 represents the electric field intensity 305 of X-rays and is an electric field intensity distribution about one of the waveguide modes formed in the material. A small space of the large number of the circles represents that the electric field intensity is high and a large space of the large number of the circles represents that the electric field intensity is low. At the center portion of the air holes 301, the space of the circle is small and the electric field intensity 305 is high. The space of the circle increases while inclining from the center portion in the circumferential direction of the hole, so that the space of the circle is large at the peripheral portion of the hole and the electric field intensity is low. Regions in which the electric field intensity reaches the maximum and the minimum are periodically repeated in the x direction and in the y direction, so that the electric field concentrates on the holes (basic structures of the periodic structure body) of the periodic structure body. The air holes 301 represent the basic structures of the periodic structure body. Reference number 304 denotes a period direction.

### Confinement Relationship

In the X-ray waveguide for use in the invention, a waveguide mode in a case where a uniform medium having an average refractive index is used for the entire core is present, in addition to the periodic resonant waveguide mode, which is hereinafter referred to as a uniform mode.

In contrast to the uniform mode, the periodic resonant waveguide mode used in the X-ray waveguide for use in the invention has little loss as compared with an approaching mode, and has a uniform phase. The X-ray waveguide for use in the invention is designed in such a manner that the structural periodicity 303(d) satisfies the following Equation (4) in order to form the above-described periodic resonant waveguide mode, in addition to the uniform mode, by the total reflection on the interface of the cladding and the core.

In particular, when the core is sandwiched between two claddings (FIG. 3), the period direction of FIG. 3 is brought into agreement with a direction perpendicular to the wave-guiding direction and a direction perpendicular to the claddings.)

$${θ}_{C} > {θ}_{B} \approx \frac{180}{π} arc sin ( \frac{1}{{n}_{avg}} m \frac{λ}{2 d} ) \qquad ( 4 )$$

θ_{C}(°) is the total reflection critical angle on the interface of the cladding and the core. θ_{B}(°) is the Bragg angle by the structural periodicity d in the period direction. λ is the wavelength of X-rays. n_{avg} is the real part of the average refractive index of the core.

Under the conditions, not only the uniform mode but the periodic resonant waveguide mode is present in the X-ray waveguide for use in the invention. In the periodic resonant waveguide mode in the X-ray waveguide for use in the invention, the periodic structure body is finite. Therefore, when assuming that the periodic structure body is infinite, the mode formed in the periodic structure body is a mode which is modulated by the waveguide structure confined by the total reflection on the interface of the cladding and the core. However, almost similarly as in the case where the periodic structure body is infinite, the antinode portion and the node portion in which the electric field intensity of the electric field intensity distribution in the periodic resonant waveguide mode in a plane perpendicular to the propagation direction is the maximum are in agreement with the basic structures of the periodic structure, respectively. Since the loss in such a periodic resonant waveguide mode becomes remarkably lower than that of the approaching uniform mode, wave-guiding of mode-selected X-rays can be achieved.

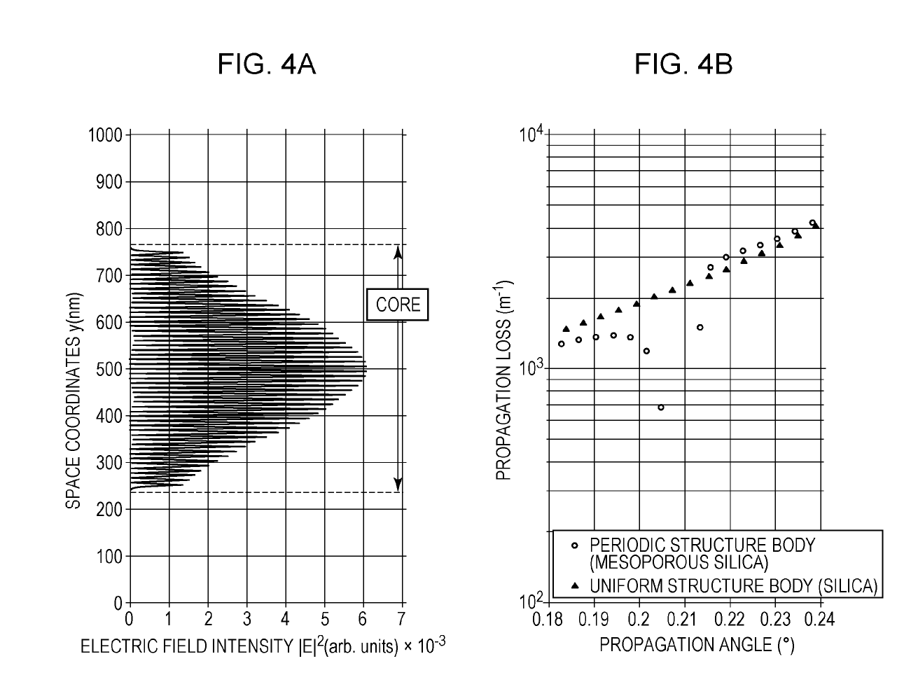

FIGS. 4A and 4B are views illustrating a waveguide mode (periodic resonant waveguide mode) originating from the periodic structure. FIG. 4A illustrates the profile of the electric field intensity of the periodic resonant waveguide mode in a waveguide in which mesoporous silica, described later, is used for the core and gold is used for the cladding, in which the maximum portion of the electric field intensity is in agreement with pore portions of mesoporous silica. In the periodic resonant waveguide mode, the electric field intensity concentrates near the core center, and bleeding to the cladding hardly occurs, so that a waveguide mode in which the phase profile is controlled is realized. FIG. 4B is a view illustrating the propagation angular dependence of the X-ray propagation loss, and shows that the waveguide mode of a propagation angle of about 0.205° corresponds to the periodic resonant waveguide mode, and the propagation loss thereof becomes remarkably small as compared with the propagation loss of other waveguide modes. The propagation angle of the periodic resonant waveguide mode is slightly smaller than the Bragg angle of the periodic structure body. These results are obtained by theoretically calculating the waveguide modes which can be present in the waveguide by a finite element method.

As illustrated in FIG. 4B, in the X-ray waveguide in which the core is constituted by a uniform silica, the periodic resonant waveguide mode is not present and the propagation loss merely monotonously increases with an increase in the propagation angle. In contrast, by the use of the periodic structure body for the core, a periodic resonant waveguide mode in which the propagation loss is remarkably small can be selectively extracted. Furthermore, the X-ray waveguide for use in the invention has an advantage in that, as an increase in the periodicity of the periodic structure body of the core, a resonance effect with the periodic structure becomes noticeable and the propagation loss decreases. This is because the contribution of the multiple reflection by the periodic structure body becomes higher. It is desirable that the periodicity of the periodic structure of the core of the X-ray waveguide for use in the invention is 10 or more, suitably 50 or more, depending on the target X-ray wavelength range or the size of the structural periodicity 303.

The increase in the periodicity of the periodic structure is equivalent to increasing the cross-sectional area of the X-ray waveguide 101. Therefore, the X-ray waveguide 101 for use in the invention has the most distinctive feature in that the cross-sectional area of the core is larger than before and X-ray beams having spatial coherence of a large space region can be generated. Utilizing the feature, the X-ray holography light source element of the invention divides the X-ray beam having high spatial coherence into two beams by the shield member 102 to thereby obtain the object light 105 and the reference light 103 which are coherent to each other. Therefore, since the object light 103 and the reference light 104 can be emitted from positions apart from each other without curving the X-ray waveguide, a double image in holography can be clearly separated to form an image.

### Cladding Material

The refractive-index real part of a substance at the cladding side on the interface of the cladding and the core is referred to as n_{cladding} and the refractive-index real part of the core on the interface is referred to as n_{core}. The total reflection critical angle θ_{C} (°) from a direction parallel to the film surface in this case is represented by the following Equation (5) under the relationship of n_{cladding}<n_{core}.

$${θ}_{C} = \frac{180}{π} arc cos ( \frac{{n}_{clad}}{{n}_{core}} ) \qquad ( 5 )$$

The cladding material of the X-ray waveguide for use in the invention can be constituted by a material in which other structural parameters and the physical property parameters of the waveguide satisfy Equation (5). For example, when a mesoporous silica which is a two-dimensional periodic structure in which pores are arranged in the shape of a triangular lattice with a period of 10 nm in a confined direction is used for the core, the cladding can be constituted by Au, W, Ta, or the like.

However, it is suitable to use a material with a low absorptivity of X-rays of a target wavelength range (energy range) of the X-ray holography light source element of the invention for the material of the cladding. In particular, it is suitable to use a material having no absorption end of X-rays in the target wavelength range of X-rays for the cladding.

### Material of Periodic Structure Body

For materials of the periodic structure body for use in the core of the X-ray waveguide for use in the invention, a periodic structure body or the like which is produced by a former top-down process or a self-assembly process can be used without being particularly limited. For example, a multilayer film formed by sputtering or a vapor deposition method, a periodic structure body formed by photolithography, electron beam lithography, an etching process, lamination, pasting, or the like, etc., can be used. In particular, by the use of oxides for substances constituting the periodic structure body, oxidation degradation can be prevented.

As the core of the X-ray waveguide for use in the invention, it is suitable that the core is a mesostructure film containing an amphiphilic organic substance and an inorganic substance particularly in terms of simpleness of a manufacturing process thereof or a periodic structure body with high regularity and it is more suitable that the core is a mesoporous film in which the organic substance is removed from the mesostructure film from the viewpoint of the penetration of X-rays. This is described below.

The mesostructure film in the invention is a composite material film in which an organic component and an inorganic component are alternately disposed at a scale of a nanometer order. The organic component is one in which amphiphilic substances typified by surfactants or block polymers has self-assembled. By utilizing the self-assembly of the amphiphilic substance, the mesostructure film having high structural regularity can be formed. The structure includes a one-dimensional periodic structure in which a laminar structure is the basic structure and the laminar structure is laminated, a two-dimensional periodic structure in which a cylindrical structure is the basic structure and the cylindrical structure is laminated, and a three-dimensional periodic structure in which a cage structure is the basic structure and the cage structure is laminated. The mesoporous film is one in which the organic component is removed from the mesostructure film and is a film of a porous material in which pores are arranged with a high order. However, in the invention, the organic component may remain in the pores of the mesoporous film insofar as the mesoporous film has a required performance.

The “meso” of the mesoporous film refers to the fact that the size is 2 to 50 nm according to IUPAC (International Union of Pure and Applied Chemistry). Therefore, the mesoporous film is defined as a porous film in which the pore diameter is 2 to 50 nm. In the mesostructure film and the mesoporous film, a periodic structure is formed in a self-assembly manner by giving a reaction liquid mainly containing a precursor of oxides and amphiphilic substances typified by surfactants and block polymers by a process, such as coating, onto a substrate. In a process employing amphiphilic molecules, a periodic structure due to the self-assembly thereof is formed, and therefore a periodic structure body with high regularity can be formed. Therefore, the periodic structure body can be produced with extreme ease and with a high throughput without requiring a large number of processes, such as a former top-down process. The formation of a periodic structure body of tens of nanometers is very difficult to achieve by a former top-down process, and in particular, it can be said that it is almost impossible to produce two or more dimensional periodic structure bodies.

The mesostructure film for use in the invention forms a periodic structure body with inorganic components and organic components. For the inorganic components, inorganic oxides are suitably used, and silica, titanium oxide, zirconium dioxide, and the like can be mentioned. As the organic components, amphiphilic molecules typified by surfactants or block polymers, alkyl chain portions of block polymers and siloxane oligomers, or alkyl chain portions of silane coupling agents can be mentioned, for example. As the surfactants and block polymers, C12H25(OCH2CH2)4OH, C16H35(OCH2CH2)10OH, C18H37(OCH2CH2)10OH, Tween 60 (Tokyo Kasei Kogyo), Pluronic L121 (BASF A.G.), Pluronic P123 (BASF A.G.), Pluronic P65 (BASF A.G.), Pluronic P85 (BASF A.G.), and the like can be mentioned. By appropriately selecting the type, the molecular weight, the molecular weight ratio of a hydrophilic portion and a hydrophobic portion, and the like of the inorganic components and the organic components, the dimension or the structural periodicity (plane interval obtained from the Bragg diffraction) of the periodic structure of the periodic structure body can be adjusted. Table 1 shows the structure of the periodic structure body to the organic substance to be used.

TABLE 1

| | Dimension of | Structural |
|---|---|---|
| Organic substance | periodic structure | periodicity (nm) |
| Pluronic L121 | One dimension | 11.6 |
| Pluronic P123 | Two dimension | 10.4 |
| Pluronic P85 | Two dimension | 9.3 |

The mesostructure film of the invention is formed by giving a reaction liquid containing the organic component and the precursor of the inorganic component thereof to a substrate or the like and using a self-assembly process. As a method for giving the reaction liquid, known methods can be used. Methods for applying the reaction liquid to a substrate by spin coating or dip coating, a hydrothermal synthesis method including bringing the reaction liquid into contact with a substrate and holding the same, and then heating the same, and the like can be mentioned. In this case, by the use of known methods, e.g., subjecting a substrate to an anisotropic process by, for example, forming a polyimide film which is subjected to rubbing treatment on a substrate, applying a shearing stress to a substrate when giving the reaction liquid, or the like, a mesostructure film can be formed in which the orientation direction is uniform in one direction in the plane of the substrate. By bringing the orientation direction into agreement with the X-ray wave-guiding direction, the X-ray waveguide with a smaller propagation loss to be used in the invention can be provided.

In order to produce the mesoporous film from the mesostructure film, the organic component can be removed by known methods, such as firing, extraction by an organic solvent, or ozone oxidation treatment.

For the material of the periodic structure body which is the core, it is suitable to use a material with a low absorptivity of X-rays of a target wavelength range (energy range) of the X-ray holography light source element of the invention. In particular, it is suitable to use a material having no absorption end of X-rays in the target wavelength range of X-rays for the cladding.

### Confinement Dimension

The dimension of confining X-rays of the X-ray waveguide for use in the invention may be one-dimension in which a film-like core is sandwiched between claddings or may be two dimension in which a core whose cross-section perpendicular to the wave-guiding direction has a circular or rectangular shape is surrounded by a cladding. In a two dimensional confinement waveguide, X-rays are two dimensionally confined in the waveguide. Therefore, X-ray beams in which diverging properties are suppressed and the phase is two dimensionally controlled as compared with those of a one dimensional confinement waveguide can be extracted. As a result, in the case of the two dimensional confinement waveguide, the object light 103 and the reference light 102, which are obtained by dividing the guided light, two dimensionally interfere with each other to thereby form a two-dimensional holographic image. Furthermore, when the periodic structure body is a two-dimensional structure (basic structure: cylindrical structure) or a three-dimensional structure (basic structure: cage structure), the electric field intensity distribution originating from a plurality of periodic structures in a plurality of period directions can be more efficiently formed in the core. More specifically, a two-dimensional periodic resonant waveguide mode can be selectively extracted on the waveguide cross-section, and the object light 103 and the reference light 104 which have high intensity and are two dimensionally coherent to each other can be provided.

An X-ray waveguide of a two dimensional confinement structure for obtaining a two-dimensional periodic resonant waveguide mode is described in detail below. The two-dimensional structure of the periodic structure body in this case is a structure in which the periodicity can be expressed by two basic vectors in a plane perpendicular to the wave-guiding direction.

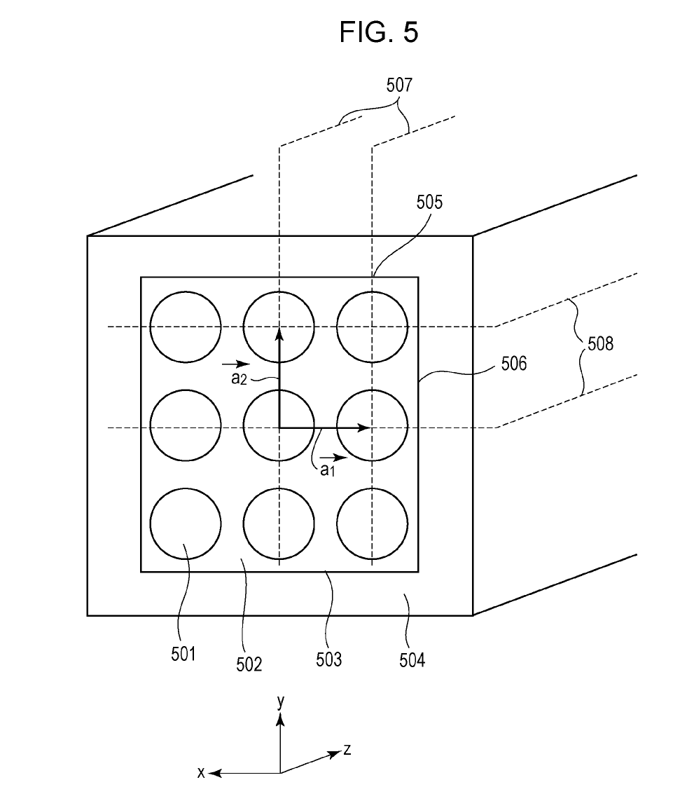

FIG. 5 is a schematic view illustrating a two dimensional confinement X-ray waveguide. For example, as illustrated in FIG. 5, a configuration is mentioned in which a core 503 in which a region 501 of a substance having a large refractive-index real part and a region 502 of a substance having a small refractive-index real part extending in the z direction form a periodic structure in a two dimensional direction in the x-y plane is surrounded by a cladding 504. When the X-ray wave-guiding direction is the z direction, the core has a two-dimensional periodic structure of a square lattice arrangement in the x-y plane perpendicular to the wave-guiding direction, and the periodicity of the periodic structure is expressed by two basic vector a₁ and a₂ illustrated in the drawing. The periodicity of the periodic structure of FIG. 5 is low in both the x and y directions, which simplifies the description. The two-dimensional periodic structure has a structure in which a plane of one structure which serves as one base is repeated at a period |a₁| in a direction parallel to a₁ and a plane of a structure which serves as another base is repeated at a period |a₂| in a direction parallel to a₂. The basic vectors a₁ and a₂ can be arbitrarily selected insofar as the periodicity can be expressed. More specifically, another basic vector can be selected by changing the selection manner or using linear combination of the basic vectors even in the same periodic structure. A plane of the structure which serves as the base corresponding to the selected basic vector can be defined. One in which the absolute value of the basic vector is the minimum expresses the most basic periodicity. The periodicity effect becomes higher in a direction parallel to such a basic vector. It is effective to define these directions as specific directions for the formation of a periodic resonant waveguide mode. When a₁ and a₂ are selected as the basic vectors in the example of FIG. 5, the planes of the structures which serve as the base are planes 507 and 508 to a₁ and a₂, respectively, and are periodically repeated in the x direction and the y direction.

Also when the core contains a two-dimensional periodic structure, in the X-ray waveguide for use in the invention, the core and the cladding are constituted in such a manner that the Bragg angle corresponding to the periodicity of the periodic structure in at least one specific direction perpendicular to the X-ray wave-guiding direction is smaller than the total reflection critical angle on at least one interface of the core and the cladding. In the case of the example illustrated in FIG. 5, when one specific direction is defined as the y direction in the x-y plane perpendicular the wave-guiding direction, the cladding and the core are constituted in such a manner that the Equation (4) is satisfied between the total reflection critical angle θ_{C} of X-rays on the interface 505 of the core and the cladding in the y-z plane and the Bragg angle θ_{B} obtained by the periodicity in the y direction.

When the core is a two-dimensional periodic structure, the basic periodicity is obtained in two specific directions represented by the two basic vectors. Therefore, two Bragg angles corresponding to the periodicity in the directions can be defined. For example, in the case of the X-ray waveguide of the configuration of FIG. 5, the two specific directions are defined as the x direction and the y direction parallel to the basic vectors a₁ and a₂. The Bragg angles θ_{B1} and θ_{B2} corresponding to the periodicity of the periodic structure in the two specific directions parallel to the basic vectors a₁ and a₂ are represented by the following Equations (6) and (7), respectively.

$$\begin{matrix}{θ}_{B 1} \approx \frac{180}{π} arc sin ( \frac{1}{{n}_{1 avg}} m \frac{λ}{2 \vert {a}_{1} \vert} ) & ( 6 ) \\ {θ}_{B 2} \approx \frac{180}{π} arc sin ( \frac{1}{{n}_{2 avg}} m \frac{λ}{2 \vert {a}_{2} \vert} ) & ( 7 )\end{matrix}$$

n_{1avg} and n_{2avg} are the average refractive indices in the two specific directions parallel to the basic vectors a₁ and a₂ in the core, respectively. The total reflection critical angles on the interfaces 506 and 505 of the core and cladding in the two specific directions parallel to the basic vectors a₁ and a₂ are defined as θ_{1C} and θ_{2C}, respectively. In this case, in order to form periodic resonant waveguide modes in the directions, materials and structural parameters are determined in such a manner as to establish θ_{1B}<θ_{1C} and θ_{2B}<θ₂ in the directions similarly as in Equation (4).

When configured in such a manner that θ_{1B}<θ_{1C} and θ_{2B}<θ_{2C} are satisfied and the total reflection critical angles on the interface of substances in the core in the directions are smaller than the Bragg angles thereof, periodic resonant waveguide modes can be formed in the two specific directions. The periodic resonant waveguide modes obtained in such a waveguide are two-dimensional periodic resonant waveguide modes in which the periodic resonant waveguide modes in two specific directions parallel to the two basic vectors interfere with each other.

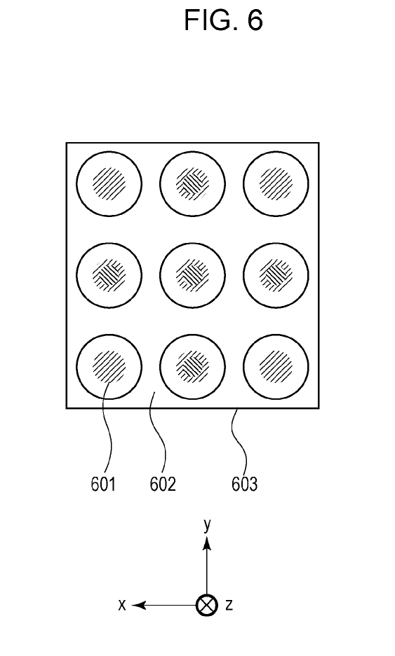

FIG. 6 is a view illustrating the electric field intensity distribution of the periodic resonant waveguide mode in the core 603 on a plane perpendicular to the z direction of the X-ray waveguide of FIG. 5. In FIG. 6, a diagonally shaded area at the center portion of 601 and a circumferential portion of the diagonally shaded area of 601 and a portion 602 represent a portion with a higher electric field intensity and a portion with a lower electric field intensity, respectively. More specifically, the electric field intensity distribution of the two-dimensional periodic resonant waveguide mode formed in the X-ray waveguide in which the two-dimensional periodic structure is the core is two-dimensional distribution and an electric field concentrates on a region where loss, such as absorption, is smaller, which shows that the propagation loss of the periodic resonant waveguide mode is small. Also in the two-dimensional periodic resonant waveguide mode, the loss can be made smaller than that of other waveguide modes depending on a design similarly as in the one-dimensional periodic resonant waveguide mode, and a single waveguide mode controlled in the two dimensional direction can be formed. The electric field or magnetic field distribution of the two-dimensional periodic resonant waveguide mode is regularly controlled in a two-dimensional plane perpendicular to the wave-guiding direction, and the phases of the electric fields or the magnetic fields become regular in the entire core.

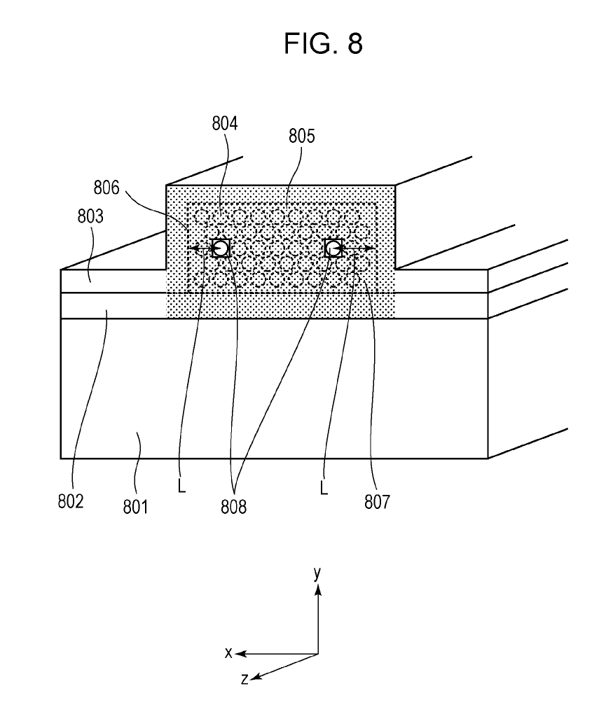

The principal lattice defining the periodicity of the two-dimensional periodic structure forming the core is not limited to the square lattice. In the example in which the periodic structure body is a square lattice as illustrated in FIG. 5, two specific directions parallel to the two basic vectors are defined as specific directions. However, the direction is not limited to such a direction, and a direction parallel to a vector using linear combination of the basic vectors can also be used as a specific direction. The number of the specific directions in the two-dimensional plane is not limited to two, and there is a case where the number of the specific directions is 3 or more depending on the periodicity of the periodic structure. For example, FIG. 8 illustrates one in which a triangular lattice like two-dimensional periodic structure is represented by dots. In this case, by considering a specific direction parallel to a third vector denoted by a₁-a₂ in addition to the two specific directions parallel to the basic vectors a₁ and a₂, X-rays having perpendicular components of three directions interfere with each other to form a two-dimensional periodic resonant waveguide mode. The electromagnetic field intensity distribution of the periodic resonant waveguide mode in this case has a triangular lattice shape, and a distribution is obtained in which an electromagnetic field concentrates on a portion with smaller absorption loss.

The periodic structure forming the core is not limited to the two-dimensional periodic structure, and an X-ray waveguide can be formed also using a three-dimensional periodic structure body as the periodic structure. The forming manner of the periodic resonant waveguide mode in the plane perpendicular to the wave-guiding direction is the same as those of the one-dimensional structure and the two-dimensional structure. In the case of the three-dimensional periodic structure body, due to the fact that there is periodicity also in the wave-guiding direction, a wave-guiding X-ray resonates with the periodic structure, so that an effect is obtained that the phases of X-rays are easily made uniform in the wave-guiding direction.

### Incident X-ray

When carrying out X-ray holography using the X-ray holography light source element of the invention, the incident X-ray 104 may have monochromaticity. Therefore, the incident X-ray 104 may be monochromatized using a crystal or multilayer film monochromator, for example, and then made to enter the X-ray holography light source element of the invention. However, the invention is not limited thereto when the X-ray detector 108 has energy (wavelength) resolution, for example.

### Shield Member

The shield member 102 provided with the opening portions 103 in FIG. 1 may be constituted by any material insofar X-rays in an unnecessary region are removed by absorption or the like to divide X-rays emitted from the X-ray waveguide 101 to thereby emit mutually coherent beams. The removal of X-rays occurs mainly due to the absorption by the shield member. Therefore, the thickness of the shield member 102 is required corresponding to a length with which unnecessary diffracted X-rays can be sufficiently absorbed and may be designed as appropriate. For example, when an incident X-ray with energy of 10 keV is made to enter and tungsten is used for the shield member, the length may be 100 μm or more depending on the intensity of the X-ray. The opening portions 103 may be individually disposed at portions in which the phase profiles of the periodic resonant waveguide modes have the same shape to emit X-rays, and the object light 105 and the reference light 106 suitably become coherent to each other. Furthermore, the distance from the end portion of the X-ray waveguide 101 of the shield member 102 needs to be shorter than the shortest wavelength of the incident X-ray 104. This is because when the distance therebetween is equal to or larger than the length, a diffraction phenomenon when emitted from the X-ray waveguide 101 cannot be disregarded.

Depending on the thickness of the shield member and the size of the opening portions, the opening portions 103 function as the X-ray waveguide and form a waveguide mode within the opening portions. In general, when (Size of opening portion)/(Thickness of shield member) is small, the opening portions easily function as the X-ray waveguide.

The size of the opening portions determines the resolution of a holographic image and is suitably in the range of 10 nm to 10 μm.

The opening portions 103 may be coated with a material which allows penetration of X-rays at a desired intensity. When the size of the opening portions 103 is the smaller small, the object light 105 and the reference light 106 with which an X-ray holographic image with higher resolution is obtained can be provided and the resolution of the X-ray holography is the same as the size of the opening portions 103. In addition, the object light 105 and the reference light 106 may be able to be extracted, and two or more of the opening portions 103 for obtaining the object light 105 and the reference light 106 may be provided.

### X-ray Detector

For the X-ray detector 108 constituting the X-ray holography system, point detector, one dimensional, and two dimensional detectors can be used and is not limited insofar as an X-ray of the wavelength of the incident X-ray 104 can be detected. The use of the two dimensional detector eliminates the necessity of causing the detector to scan, and therefore a holographic image can be obtained in a short time. The X-ray detector 108 may be disposed at a position apart from the shield member 102 as much as possible on the z axis in such a manner as to obtain an interference pattern of the object light 105 and the reference light 106 with a high resolution. The X-ray detector 108 may be disposed in a region where the influence of scattering or absorption of the object light 105 and the reference light 106 caused by air or the like is minimized and negligible.

Hereinafter, the invention is specifically described with reference to Examples but is not limited thereto.

### EXAMPLE 1

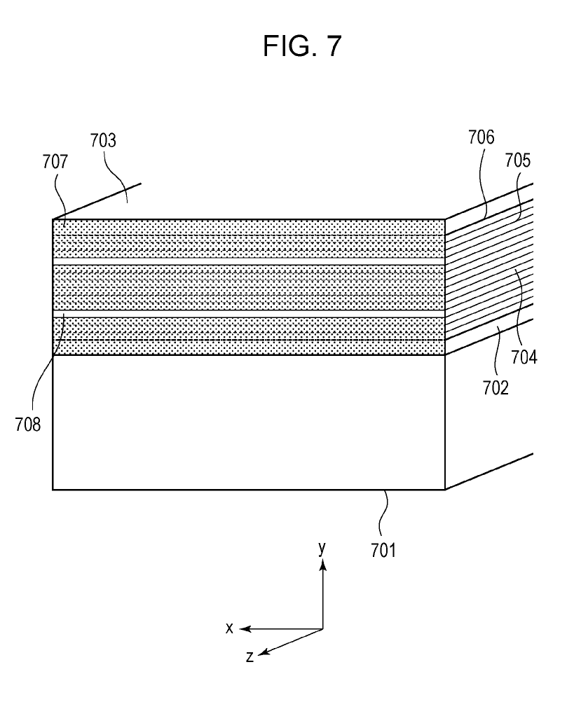

This example describes an example of an X-ray holography light source element which includes an X-ray waveguide constituted by a cladding containing tungsten and a core formed of a multilayer film containing B₄C and Al₂O₃. A shield member Ta₂O₅ having opening portions containing B₄C is disposed at the end portion of the light source element. An X-ray holography system equipped with the holographic light source element is also disclosed. FIG. 7 is a schematic view of the end portion of the X-ray holography light source element of this example. Reference numerals 701 to 708 denote a Si substrate 701, a lower tungsten cladding 702, an upper tungsten cladding 703, a B₄C layer 704, an Al₂O₃ layer 705, a periodic structure body 706, a shield member Ta₂O₅ 707, and opening portions B₄C 708, respectively.

As a method for producing the X-ray holography light source element of this example, the following processes employing a sputtering method or the like are mentioned.

### (a) Production of X-ray Waveguide

A lower tungsten cladding is formed with a thickness of 50 nm on a Si substrate by magnetron sputtering. Thereafter, as the core, substances Al₂O₃ and B₄C are alternately formed into films in this order to form a multilayer film by magnetron sputtering. The thickness of an Al₂O₃ layer and the thickness of a B₄C layer are 3.0 nm and 12.0 nm, respectively. For the layers of the lowermost portion and the uppermost portion of the multilayer film, Al₂O₃ is used. Al₂O₃ and B₄C form 301 layers and 300 layers in total, respectively. Finally, the upper tungsten cladding is formed with a thickness of 50 nm by magnetron sputtering.

In the X-ray waveguide to be obtained, the core is sandwiched between the cladding layers and X-rays are confined in the core by total reflection on the interface of the core and the cladding. According to this configuration, the relationship of the period of the multilayer film which is the structure that forms core and the refractive-index real part of substances forming the layers of the multilayer film satisfies Equation (4). For example, with respect to an X-ray of 10 keV, the X-ray is confined in the core by the total reflection on the interface of the core and the cladding, and then the confined X-ray can form a waveguide mode (periodic resonant waveguide mode) which resonates with the periodicity of the multilayer film. The total reflection critical angle at the interface of the core and the cladding is 0.3613°. The Bragg angle corresponding to the periodicity of the basic structure of the periodic structure body of the core is 0.2368°.

### (b) Production of Shield Member

A resist layer is formed on the X-ray waveguide by coating or the like, and then patterned using photolithography or a dry etching process to thereby form the end portion of the X-ray waveguide and also expose the Si substrate at the back thereof. Ta₂O₅, B₄C, Ta₂O₅, B₄C, and Ta₂O₅ are formed into films with a thickness of 550 nm, 25 nm, 3450 nm, 25 nm, and 550 nm, respectively, in this order by magnetron sputtering or a vacuum evaporation device.

### (c) Cutting of X-ray Holography Light Source Element

The X-ray holography light source element is cut by a dicing device in such a manner that the X-ray wave-guiding distance of the X-ray waveguide and the shield member length are 0.5 mm and 0.1 mm, respectively.

### (d) Evaluation of X-ray Holography Light Source Element

An incident X-ray 104 (as shown in FIG. 1) of 10 keV is made to enter the X-ray holography light source element in a state where there is no holography target (sample) 107. The incident X-ray is monochromatized using a Ge crystal monochromator. It is confirmed that the X-ray intensity pattern detected by a two-dimensional X-ray detector 108 disposed at a position 3 m apart from the shield member 103 is a clear interference pattern (Young interference pattern) having the maximum portion of the intensity at intervals of 106 μm, which shows that it functions as an X-ray holography light source element.

Next, a film which is the holography target 107 is fixed and disposed at a precision stage 1.3 mm behind the opening portions 103 emitting the object light 105. On the film, linear patterns of tungsten with a width of 0.3 μm are disposed at intervals of 0.2 μm, and the axis of the precision stage is adjusted in such a manner that the film is perpendicular to the Z axis and the linear patterns are in parallel to the x axis. The incident X-ray 104 of 10 keV monochromatized by the Ge crystal monochromator is made to enter the X-ray holography light source element, and then the X-ray intensity is measured by the two-dimensional X-ray detector 108. By re-constructing the phase information according to the Fresnel-Kirchhoff diffraction formula from the obtained detected image, an X-ray holographic image can be obtained. Furthermore, by moving the precision stage in the x axis direction and the y axis direction to thereby obtain a holographic image, and then laminating the images, the entire image of the placed holography target 107 can be obtained.

### EXAMPLE 2

This example describes an example of an X-ray holography light source element in which an X-ray waveguide constituted by a cladding containing tungsten and a core of a mesoporous silica film and a shield member Ta₂O₅ having opening portions containing B₄C at the end portion thereof are disposed and an X-ray holography system using the same. FIG. 8 is a schematic view of the end portion of the X-ray holography light source element of this example. Reference numerals 801 to 808 denote an Si substrate 801, a lower tungsten cladding 802, an upper tungsten cladding 803, pores 804, silica 805, a periodic structure body (mesoporous silica film) 806, a shield member Ta₂O₅ 807, and an opening portion B₄C 808, respectively.

Methods for producing the X-ray waveguide containing mesoporous silica of this example and the X-ray holography light source element using the same are described below.

### (a) Production of X-ray Waveguide

Tungsten is formed with a thickness of 50 nm on an Si substrate by magnetron sputtering. Thereafter, a polyimide film is formed by spin coating, and then subjected to rubbing treatment. A reaction liquid containing P123 (BASF A.G.), ethanol, water, hydrochloric acid, silica sources, such as tetraethoxysilane, and the like is spin-coated onto the substrate. The temperature in this case is 25° C. and the relative humidity is 5% or lower. After the film formation, the film is held in a thermohygrostat of a temperature of 25° C. and a relative humidity of 40% for 18 hours or more. Thereafter, the P123 and the polyimide film are removed by solvent extraction using ethanol, tetrahydrofuran, a firing process, or the like to thereby obtain a mesoporous silica film.

When the prepared mesoporous silica film is evaluated by X-ray diffraction and under an electron microscope, it is found that a triangular lattice like two-dimensional periodic structure is formed on a plane perpendicular to the wave-guiding direction (xy plane). The lattice constant is about 10.2 nm. It is also confirmed that cylindrical pores which form the basic structure of the mesoporous silica film are oriented in a direction perpendicular to a direction in which the rubbing treatment is performed. When the mesoporous silica film is partially separated, and then measured by a level difference meter, it is found that the film thickness is 510 nm.

The mesoporous silica film is patterned in such a manner as to be linear in the z axis direction using photolithography, a dry etching process, or the like. The width of the linear patterns in this case is 12 μm.

Furthermore, tungsten is formed with a thickness of 50 nm by magnetron sputtering in such a manner as to surround the linear patterns of the mesoporous silica film.

The period of the X-ray waveguide to be obtained is 10.2 nm and satisfies Equation (4). For example, with respect to an X-ray of 10 keV, the X-ray is confined in the core by the total reflection on the interface of the core and the cladding, and then the confined X-ray can form a waveguide mode (periodic resonant waveguide mode) which is affected by the periodicity of the mesoporous silica. In the periodic resonant waveguide mode, the phase is two dimensionally controlled and the periodic resonant waveguide mode has two-dimensional coherence. The total reflection critical angle on the interface of the core and the cladding is 0.3974°. The Bragg angle corresponding to the periodicity of the basic structure of the periodic structure of the core is 0.3483°.

### (b) Production of Shield Member

A resist layer is formed on the X-ray waveguide by coating or the like, and then patterned using photolithography or a dry etching process to thereby form the end portion of the X-ray waveguide and also expose the Si substrate at the back thereof. Ta₂O₅ and B₄C are formed into films with a thickness of 290 nm and 20 nm, respectively, in this order by magnetron sputtering or a vacuum evaporation device.

At positions (L of FIG. 8) 1 μm apart from two interfaces facing each other of the claddings and the core parallel to the y-axis, B₄C linear patterns with a line width of 20 nm are formed in the z axis direction by electron beam lithography. Furthermore, using magnetron sputtering or a vacuum evaporation device, Ta₂O₅ is formed into a film with a thickness of 240 nm or more to thereby produce a shield member of Ta₂O₅ having two square opening portions B₄C with one side of 20 nm.

### (c) Cutting of X-ray Holography Light Source Element

The X-ray holography light source element is cut by a dicing device in such a manner that the X-ray wave-guiding distance of the X-ray waveguide and the shield member distance are 0.5 mm and 0.1 mm, respectively.

### (d) Evaluation of X-ray Holography Light Source Element

As illustrated in FIG. 1, an incident X-ray 104 of 10 keV is made to enter the X-ray holography light source element in a state where there is no holography target (sample) 107. The incident X-ray is monochromatized using a Ge crystal monochromator. It is confirmed that the X-ray intensity pattern detected by a two-dimensional X-ray detector 108 disposed at a position 3 m apart from the shield member 103 is a clear interference pattern (Young interference pattern) having the maximum portion of the intensity at intervals of 37.2 μm, which shows that it functions as an X-ray holography light source element.

Next, a film which is the holography target 107 is fixed and disposed at a precision stage 1.3 mm behind the opening portions 103 emitting the object light 105. On the film, linear patterns of tungsten having a width of 0.3 μm are disposed at intervals of 0.2 μm, and the axis of the precision stage is adjusted in such a manner that the film is perpendicular to the Z axis and the linear patterns form an angle of 45° from the x axis. The incident X-ray 104 of 10 keV monochromatized by the Ge crystal monochromator is made to enter the X-ray holography light source element, and then the X-ray intensity is measured by the two-dimensional X-ray detector 108. By re-constructing the phase information according to the Fresnel-Kirchhoff diffraction formula from the obtained detected image, an X-ray holographic image can be obtained. Furthermore, by moving the precision stage in the x axis direction and the y axis direction to thereby obtain a holographic image, and then laminating the image, the entire image of the placed holography target 107 can be obtained.

The X-ray holography light source element of the invention can emit two or more mutually coherent X-ray beams with high intensity, and therefore can be applied to an X-ray holography system, X-ray imaging, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-108450 filed May 13, 2011, which is hereby incorporated by reference herein in its entirety.

What is claimed is:

1. An X-ray holography light source element which divides an entering X-ray to emit two or more mutually coherent X-ray beams, comprising:
an X-ray waveguide which has a core and a cladding: the core contains a plurality of substances different in a refractive-index real part and is a periodic structure body in which basic structures are periodically disposed and the cladding confines an X-ray to be guided through the core, wherein a total reflection critical angle of the X-ray on the interface of the core and the cladding is larger than a Bragg angle corresponding to the periodicity of the basic structures of the core; and
a shield member disposed at an end portion at an emission side of the X-ray waveguide and provided with two or more opening portions to respectively emit therethrough the two or more mutually coherent X-ray beams.

2. The X-ray holography light source element according to claim 1, wherein the core contains a multilayer film.

3. The X-ray holography light source element according to claim 1, wherein the core contains a mesoporous film.

4. The X-ray holography light source element according to claim 1, wherein a refractive-index real part of the core located at the interface with the cladding is larger than a refractive-index real part of the cladding.

5. The X-ray holography light source element according to claim 3, wherein the core is produced by a self-assembly process using a reaction liquid containing an amphiphilic organic substance.

6. The X-ray holography light source element according to claim 1, wherein the entering X-ray is an X-ray of a single wavelength, and wherein the periodic structure body of the core extends in a direction perpendicular to the cladding and perpendicular to the X-ray wave-guiding direction.

7. The X-ray holography light source element according to claim 1, wherein a distance from the end portion of the shield member is shorter than the shortest wavelength of the entering X-ray.

8. The X-ray holography light source element according to claim 1, wherein the opening portions are coated with a material which allows penetration of an X-ray.

9. The X-ray holography light source element according to claim 1, wherein one of the substances contained in the core is a vacuum or air.

10. An X-ray holography system, comprising:
an X-ray detector which detects an X-ray; and
an X-ray holography light source element which divides an entering X-ray to emit two or more mutually coherent X-ray beams;
wherein the X-ray holography light source element has:
an X-ray waveguide which has a core which contains a plurality of substances different in a refractive-index real part and is a periodic structure body in which basic structures are periodically disposed and a cladding which confines an X-ray to be guided, in which a total reflection critical angle of the X-ray on the interface of the core and the cladding is larger than a Bragg angle corresponding to the periodicity of the basic structures of the core, and which guides the entering X-ray; and
a shield member disposed at an end portion at an emission side of the X-ray waveguide and provided with two or more opening portions respectively emitting the two or more mutually coherent X-ray beams.
